(19) United States
(12) Patent Application Publication
(10) Pub. No.: US 2026/0136345 A1
(43) Pub. Date: May 14, 2026

(54) DYNAMIC BANDWIDTH EXPANSION (DBE) OPERATION WITH DYNAMIC SUBBAND OPERATION (DSO)

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(73) Assignee: Cisco Technology, Inc., San Jose, CA (US)

(21) Appl. No.: 19/384,510

(22) Filed: Nov. 10, 2025

Related U.S. Application Data
(60) Provisional application No. 63/718,435, filed on Nov. 8, 2024.
(60) Provisional application No. 63/829,919, filed on Jun. 25, 2025.
(60) Provisional application No. 63/881,688, filed on Sep. 15, 2025.

(51) Int. Cl. H04W 72/0457; H04W 84/12

(52) U.S. Cl. CPC H04W 72/0457; H04W 84/12

(57) ABSTRACT

Dynamic Bandwidth Expansion (DBE) operation with Dynamic Subband Operation (DSO) may be provided. A computing device may operate in Dynamic Bandwidth Expansion (DBE). Also, the computing device may operative in Dynamic Subband Operation (DSO). Then the computing device may use DSO over expanded Bandwidth (BW) of DBE for client devices that support DSO and DBE operation.

### RELATED APPLICATION

Under provisions of 35 U.S.C. § 119(e), Applicant claims the benefit of U.S. Provisional Application No. 63/718,435, filed Nov. 8, 2024, which is incorporated herein by reference. Under provisions of 35 U.S.C. § 119(e), Applicant claims the benefit of U.S. Provisional Application No. 63/829,919, filed Jun. 25, 2025, which is incorporated herein by reference. Under provisions of 35 U.S.C. § 119(e), Applicant claims the benefit of U.S. Provisional Application No. 63/881,688, filed Sep. 15, 2025, which is incorporated herein by reference.

### TECHNICAL FIELD

The present disclosure relates generally to providing Dynamic Bandwidth Expansion (DBE) operation with Dynamic Subband Operation (DSO).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Dynamic Bandwidth Expansion (DBE) operation with Dynamic Subband Operation (DSO);

FIG. 2 is a flow chart of a method for providing DBE operation with DSO;

FIG. 3 illustrates DBE operation;

FIG. 4 illustrates DBE operation with DSO;

FIG. 5 illustrates DBE operation with DSO;

FIG. 6 illustrates DBE operation with DSO;

FIG. 7 illustrates DSO enabled channel information;

FIG. 8 illustrates DSO operation with DBE expanded BW; and

FIG. 9 is a block diagram of a computing device.

### DETAILED DESCRIPTION

### Overview

Dynamic Bandwidth Expansion (DBE) operation with Dynamic Subband Operation (DSO) may be provided. A computing device may operate in Dynamic Bandwidth Expansion (DBE). Also, the computing device may operative in Dynamic Subband Operation (DSO). Then the computing device may use DSO over expanded Bandwidth (BW) of DBE for client devices that support DSO and DBE operation.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Electrical and Electronics Engineers (IEEE) 802.11bn wireless networking standard (i.e., Wi-Fi 8) in defining a Dynamic Bandwidth Expansion (DBE) feature. DBE is a mode of operation that allows a Ultra-high Reliability (UHR) Access Point (AP) to operate with an expanded operating bandwidth that is greater than its Basic Service Set (BSS) Bandwidth (BW). The DBE operation enables a UHR AP to dynamically modify (e.g., expand/change/reset) its operating BSS BW for the UHR STAs that support the DBE operation. When operating in DBE mode with an expanded BW, the UHR AP continues to serve STAs that do not support DBE operation within the BSS BW.

A DBE AP announces a dynamic BW change (expand/change/reset) using BSS parameters critical update mechanism in management frames, including in beacon, probe response and (Re)association response frames. The dynamic BW change includes enabling the DBE mode itself with an expanded DBE BW (e.g., expanding from 40 MHz BSS BW to 160 MHz DBE BW), and later AP may update the DBE BW to a different value (e.g. change from 160 MHz DBE BW to 320 MHz DBE BW or vice versa) and then at some point AP can disable the DBE mode, which can also be considered as resetting the DBE BW to the BSS BW. The dynamic BW change is announced for multiple beacon intervals in advance before the BW change takes effect. After a dynamic BW change, the DBE AP may continue operating with the updated DBE BW until a subsequent BW change occurs. While an AP is operating in DBE mode, any expanded operating BW will be greater than the BSS BW.

Dynamic Subband Operation (DSO) is a technique in wireless networking, primarily for Wi-Fi standards like IEEE 802.11bn, that allows an AP with a wider operating bandwidth to allocate resources in the secondary subband of its operating bandwidth to a client device (i.e., a non-AP STA) that operates with a narrower bandwidth. It is used at a transmission opportunity (TXOP) level and allows the AP to dynamically use its full bandwidth, even if some clients cannot operate on the wider bandwidth spectrum. This improves bandwidth efficiency and performance by letting client devices switch to different subbands on a per-TXOP basis. Consistent with embodiments of the disclosure, when an AP is operating with expanded bandwidth in DBE mode, the AP may use DSO mode for client devices that can support DSO operation over the expanded BW. The client device is also supporting DBE mode of operation for AP to use DSO over the expanded DBE BW.

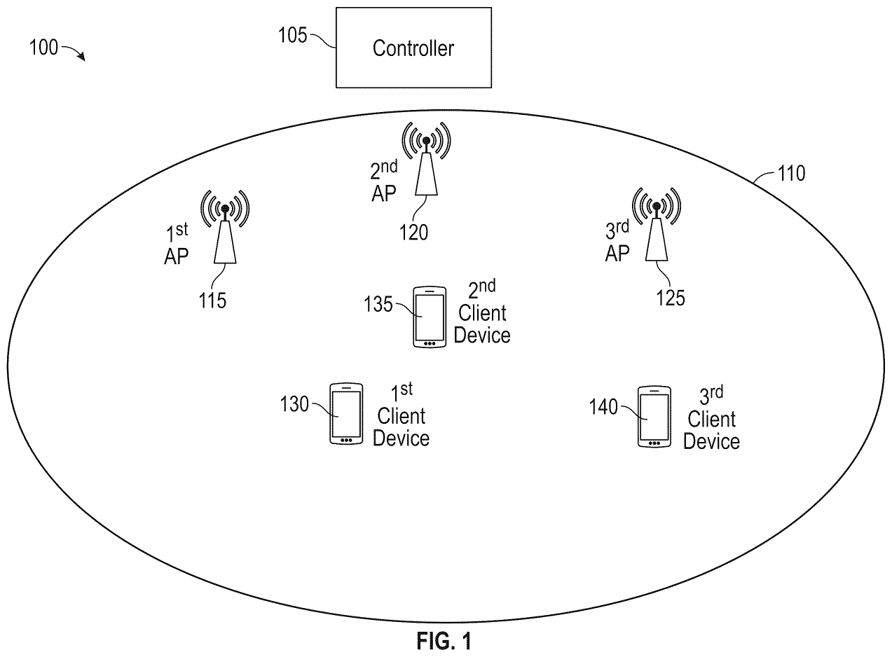

FIG. 1 shows an operating environment 100 for providing DBE operation with DSO. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs) as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi Link Operation (MLO) where they simultaneously transmit and receive across different bands (or links) and channels by establishing two or more links to two or more AP radios. These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide DBE operation with DSO. In some embodiments of the disclosure, controller 105 or another component in operating environment 100 may include an RRM (radio resource management) function that may configure information for coverage environment 110 in order to provide DBE operation with DSO.

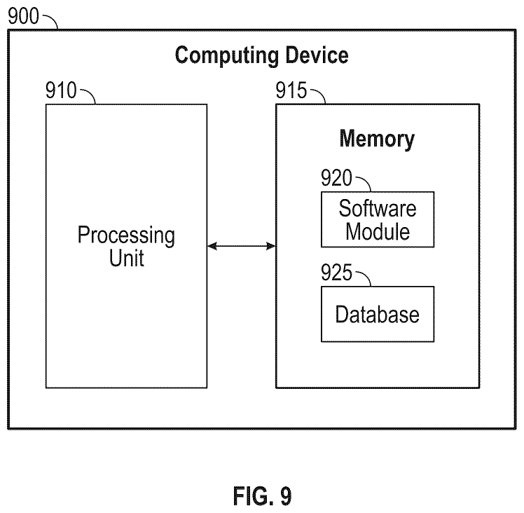

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 9, the elements of operating environment 100 may be practiced in a computing device 900.

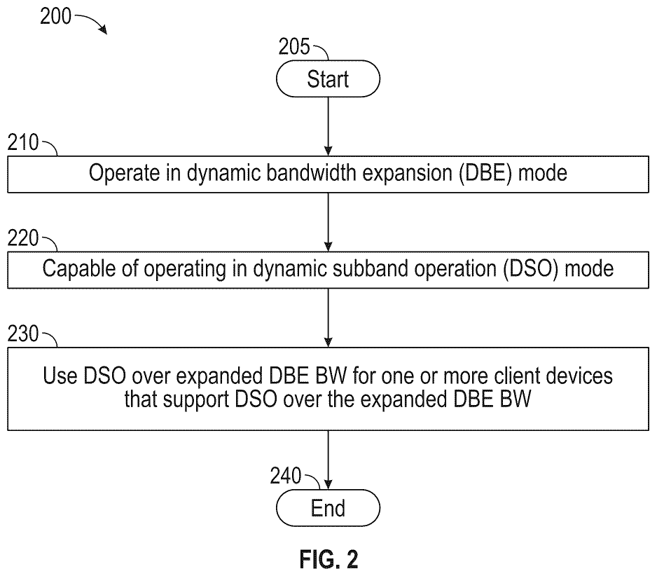

FIG. 2 is a flow chart setting forth the general stages involved in a method 200 consistent with embodiments of the disclosure for providing DBE operation with DSO. Method 200 may be implemented using a computing device 900 as described in more detail below with respect to FIG. 9. Computing device 900 may be embodied, for example, by any of the plurality of APs or controller 105. Ways to implement the stages of method 200 will be described in greater detail below.

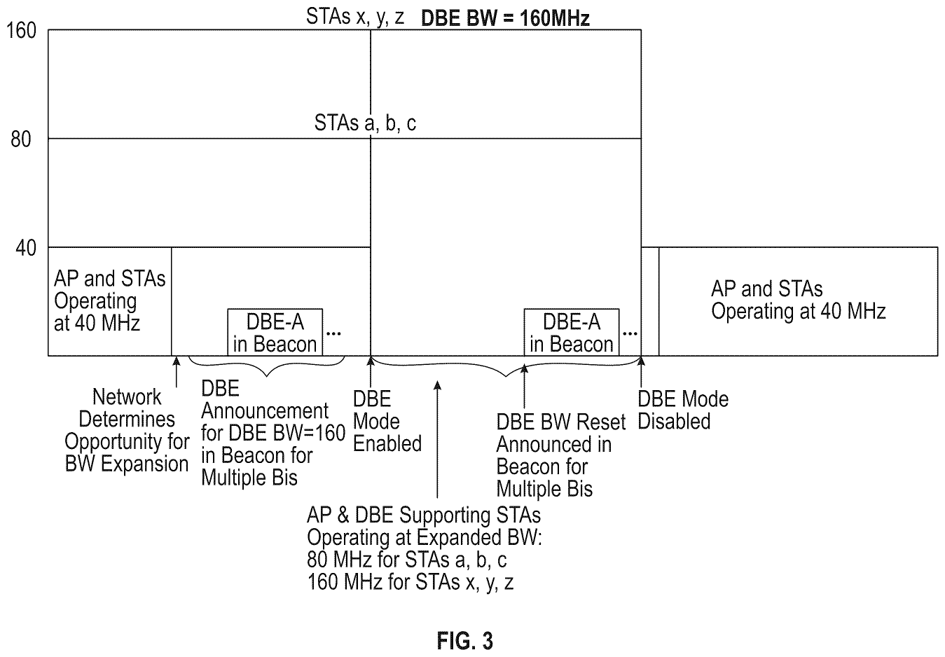

Method 200 may begin at starting block 205 and proceed to stage 210 where computing device 900 may operate in Dynamic Bandwidth Expansion (DBE) mode. For example, DBE enables an AP to dynamically expand its operating BW for DBE supporting client devices (e.g., expand BW from 40 MHz to 80/160/320 MHz). As illustrated in FIG. 3, DBE BW change may be announced in beacon, probe response, etc. using BSS parameters critical update advance notification mechanism before DBE bandwidth expansion takes effect. During expanded DBE BW operation, the AP and the DBE supporting STAs (i.e., client devices) operate with expanded DBE BW. Any subsequent DBE BW change (e.g., 160->320 MHz) or reset to BSS BW may be announced in the beacon using the same BSS parameters critical update advance notification mechanism.

From stage 210, where computing device 900 operates in the DBE mode, method 200 may advance to stage 220 where computing device 900 may be capable of operating in Dynamic Subband Operation (DSO). For example, an AP may support DSO mode of operation and/or may have already enabled DSO mode (either implicitly or explicitly). For example, the DSO mode may be defined by the amendment to be always enabled at the AP if DSO mode is supported. Then in this case, no explicit enablement of DSO mode is needed for the AP. In another embodiment, explicit DSO enablement may be performed for enabling DSO at the AP. In one embodiment, the AP may already be performing DSO operation over the BSS BW before expanding to a DBE BW. For example, if the AP is operating over 80 MHz BSS BW, it may be performing DSO for 20 MHz STAs over the BSS BW. In another embodiment, the AP may not be performing any DSO over the BSS BW before expanding to a DBE BW.

Consistent with embodiments of the disclosure, an AP and STA may indicate capability support for DSO over the DBE BW. One option for this may be to modify the ‘DSO Support’ field in UHR Capabilities to indicate support for DSO over the BSS BW and outside the BSS BW (including over the DBE BW). Another option may be for the current ‘DSO Support’ field to indicate support for DSO only over BSS BW. Then add a separate ‘DSO support over DBE BW’ parameter (e.g., in UHR Capabilities). This new parameter may be set to 1 only if ‘DSO Support’ is set to 1 (implying that DSO is supported over DBE BW only if DSO is supported over the BSS BW), or this new parameter may be set independent of DSO Support, meaning DSO may be supported over DBE BW, even when DSO is not supported over the BSS BW. In some embodiments, the AP and STA are considered to support DSO over the expanded DBE BW if they have indicated support for both DBE and DSO.

In some embodiments, the STA (and AP) may also optionally indicate a maximum DBE BW that it can support for DSO larger than the BSS BW (e.g. 160/320 MHz BW indicated for DSO by an 80 MHz STA). A ‘Max DBE BW Support for DSO’ parameter can be added-if no such parameter is indicated then the STA and AP support DSO over any DBE BW based on indication of supporting DSO over the DBE BW as described above.

Consistent with embodiments of the disclosure, STAs may support any of the following mode of operation: i) support operation with expanded DBE BW (>BSS BW), and support DSO over the expanded DBE BW; ii) support DSO over expanded DBE BW, but does not support DBE operation with expanded DBE BW; and iii) support operation with expanded DBE BW, but does not support DSO over the expanded DBE BW.

In some embodiments, when an AP supports DSO, after DBE BW expansion it may move DSO supporting STAs to DSO subbands in the expanded DBE BW, if those STAs have enabled DSO over the DBE BW. An AP may decide to expand to a wider DBE BW (e.g. 80/160/320 MHz) even if no or a small number of STAs can operate over the wider DBE BW, but there are DSO STAs that can be moved to wider BW, to serve STAs more efficiently over the wider BW.

In an example, associated STAs may support 80 MHz operating BW plus support DSO over 320 MHz, but cannot operate with 160/320 MHz wider DBE BW. The AP may still expand to DBE BW of 160/320 MHz and use DSO to serve some 80 MHz STAs in the wider DBE BW. In another example, the AP may have STA1 that can operate over 160 MHz DBE BW, other associated STAs support 80 MHz and may support DSO over 320 MHz. The AP may then expand to DBE BW of 320 MHz and use DBE to serve STA1 over 160 MHz and server some 80 MHz STAs in wider DBE BW of 320 MHz.

In summary, the AP may consider whether associated STAs can support DSO over the wider BW to determine to enable DBE mode and the corresponding DBE BW. DBE BW may be determined by the AP based on BWs over which associated STAs can operate in DBE mode and/or based on BWs over which associated STAs can perform DSO. For example, STA1 and STA2 may operate over DBE BW of 160 MHz, STA3 and STA4 are 80 MHz STAs, but can perform DSO over 320 MHz. The AP can decide to expand to DBE BW of 320 MHz. The AP can serve STA1 and STA2 in P160 subband of 320 MHz DBE BW and can serve STA3 and STA4 in S160 by moving those STAs to S160 subband using DSO, to utilize the entire 320 MHz expanded DBE BW.

Once computing device 900 that is capable of operating in DSO mode in stage 220, method 200 may continue to stage 230 where computing device 900 may use DSO over expanded DBE Bandwidth (BW) for one or more client devices that support DSO over the expanded DBE BW. For example, DSO mode at the AP may be enabled/disabled dynamically and may be indicated in the UHR Operation element (e.g., by setting DSO Enabled bit to 1). The AP may also signal whether DSO is enabled over the expanded DBE BW. In a first option for this the ‘DSO Enabled’ field may be extended to signal support for DSO over both the BSS BW and the expanded DBE BW. When DSO Enabled is set to 1, it may also indicate DSO enabled over any DBE BWs when DBE mode is enabled. The AP may signal a ‘Max DBE BW Supported for DSO’ or ‘Max expanded BW supported for DSO’ parameter, if DSO is supported over smaller BW than the DBE BW.

In a second option, the DSO Enabled field only indicates DSO is enabled for the BSS BW. A separate ‘DSO Enabled over DBE BW’ field indicates whether AP has DSO enabled over the DBE BW. A separate indication gives flexibility to the AP to enable DSO separately for BSS BW and DBE BW. As above, the AP may also signal a ‘Max DBE BW Supported for DSO’ indicating max DBE BW over which DSO is supported if DSO is supported over smaller BW than the DBE BW (e.g., DSO supported for 160 MHz when DBE BW is 320 MHz). The AP may have ‘DSO Enabled over DBE BW’ independent of the DSO Enabled over BSS BW (e.g. when BSS BW is narrow (20/40 MHz) the AP may not enable DSO over the BSS BW but can enable DSO over expanded DBE BW when DBE mode is enabled). Alternatively, the AP may have DSO enabled over DBE BW only if DSO is also enabled over the BSS BW.

In some embodiments, the DSO may always be enabled at the AP if the AP supports DSO mode. The AP may still decide when to use DSO for moving STAs to secondary subbands (i.e., AP may not be moving STAs to secondary subbands always even if DSO is enabled always). In some embodiments, AP enables using DSO over the expanded DBE BW if the AP has indicated support for DSO (and/or has enabled DSO either implicitly or explicitly) and also has enabled DBE.

There may be two cases for DBE operation with DSO: i) DSO is enabled at the AP before DBE mode is enabled; and ii) DSO is not enabled at the AP before DBE mode is enabled. An example of the first case might comprise where an AP's BSS BW is 80 MHz, DSO is enabled, and the AP can perform DSO for 20 MHz STAs. Another example of the first case may comprise the AP's BSS BW is 160 MHz, DSO is enabled, and the AP can perform DSO for 20 MHz STAs and 80 MHz STAs. In the second case where DSO is not enabled at the AP before DBE mode is enabled, an AP may be operating at 20/40/80/160 MHz, but there may be no associated 20 MHz STAs that support DSO (or DSO is not allowed for 20-MHz STAs) or the AP does not have DSO enabled. In both of the aforementioned cases, when DBE mode is enabled, the AP can perform DSO over the expanded DBE BW for STAs that can support DSO over the expanded DBE BW. The following aspects may be addressed: i) announcement of DSO enabled over the DBE BW; and ii) STA enablement and negotiation for DSO over the DBE BW.

### Announcement of DSO Enabled Over the DBE BW

In some embodiments, the AP may explicitly announce/advertise enablement of DSO in general or enablement of DSO over the DBE BW e.g. in beacon, probe response or (re)association response frames. In these cases, the AP may indicate DSO is enabled over DBE BW either using DSO Enabled field or a separate ‘DSO Enabled over DBE BW’ field (as stated above). Maximum DBE BW supported for DSO may be signaled (e.g. <DBE BW), or DSO may be assumed to be enabled over the DBE BW. The AP may indicate DSO enablement over DBE BW as part of BSS parameters critical update notifications to the STA (e.g., when the AP is not already indicating DSO enabled over DBE BW in the UHR Operation). In one option, as part of DBE BSS parameters critical update announcement/notification when enabling (or updating/disabling) DBE mode, the AP may also signal DSO enablement over expanded DBE BW (or for a BW smaller than the DBE BW). Here, BSS parameters critical update notification for enabling DSO over DBE BW may be combined with BSS parameters critical update notification for DBE mode enablement (or update/disablement). In another option, the AP may send a separate BSS parameters critical update notification that signals DSO enabled over the DBE BW (or over a smaller BW than the DBE BW e.g. DSO over 160 when DBE BW is 320 MHz). If the AP is disabling DBE mode, then it may also disable DSO over the DBE BW in the same BSS parameters critical update notifications. If critical updates for DBE and DSO (over DBE BW) are combined, then the critical updates for DBE and DSO enablement (disablement/update) can still be encoded differently but transmitted as part of same BSS parameters critical update notifications.

Typically, both DBE and DSO BSS parameters critical updates may have the same start/switch time and become effective at the same time. However, an AP may also enable DSO over the DBE BW, sometime after the DBE mode is enabled, if the AP does not see the need to enable DSO right away over the DBE BW. In the critical update notification for DSO, the AP may indicate whether DSO is being enabled only for DBE BW or BSS BW (or both) and provide any related DSO parameters (e.g. Max DBE BW for DSO).

### STA Enablement and Negotiation for DSO Over the DBE BW

In some embodiments, a STA may need to enable both DBE and DSO with the AP to use DSO over the DBE BW. Before DBE is enabled, some STAs may have enabled/negotiated DSO subbands over BSS BW (e.g., when BSS BW is 80 MHz, 20 MHz STAs may enable DSO and negotiate a 20 MHz DSO subband assignment for the STA).

After DBE is enabled with wider BW, STAs that may perform DSO over DBE BW may need to enable DSO and/or (re)negotiate DSO subbands over the DBE BW. If the AP is expanding to 160/320 MHz DBE BW, then 80 MHz STAs may need to enable/negotiate allocated DSO subband(s). If an STA already has A DSO subband negotiated, then it can continue to use the negotiated DSO subband as long as it lies within the DBE BW. If 20 MHz STAs can be moved to wider DBE BW, then they may renegotiate allocated DSO subband(s) over the DBE BW.

It is also desirable to avoid gold rush or storm of lots of STAs rushing to enable DSO over the DBE BW when the DBE mode is enabled/updated, to avoid high signaling overhead and congestion on the network. For example, the following may help to avoid a gold-rush of STAs performing DSO enablement/negotiation with AP after DBE is enabled. A STA should perform DSO enablement/negotiation during the time when the critical update announcement is being sent for enabling DBE and/or DSO over the DBE BW. This will include the number of beacon intervals over which the DBE mode enablement/update is announced. STAs should enabled DSO over the DBE BW over these beacon intervals where DBE mode enablement/update is being announced. The AP should also accept DSO enablement/negotiation over the DBE BW from STAs even after the DBE mode enablement/update has become effective. Different STAs may randomize their DSO enablement over the critical update announcement period of DBE by choosing a random time during that period.

In some embodiment, if the AP has indicated that DSO is enabled over DBE BW (either implicitly or explicitly) even before enabling DBE mode, then the STA may enable DSO over DBE BW even before DBE mode is enabled. This way when DBE is enabled, both AP and STAs may operate with DSO mode over DBE BW without any delay of DSO enablement from the STA. The STA may use UHR generic enablement/disablement mechanism (or operating mode and parameters (OMP) procedure) to enable DSO over the DBE BW (e.g., signaling ‘DSO enabled over DBE BW’ or just signaling DSO enabled with DSO parameters for the DBE BW). The STA may indicate ‘Max DBE BW Support for DSO’ (e.g., 160 or 320 MHz). If not indicated, then the STA may be enabling DSO support over all possible DBE BWs. When enabling DSO over DBE BW before the DBE mode is enabled (or DBE BW is updated), a STA may enable and negotiate DSO parameters with the AP for multiple possible DBE BWs, that may be selected by the AP in future for DBE operation. For example, the STA may enable and negotiate DSO parameters for one or more of 40/80/160/320 MHz DBE BWs. Later when DBE mode is enabled for one of those possible DBE BWs, then the STA can use the already negotiated DSO parameters for DSO operation over that DBE BW. A STA may also renegotiate DSO parameters (if needed) after DBE mode is enabled or DBE BW is updated. A STA may combine enablement of DSO over DBE BW along with the enablement of DBE mode itself. If the STA is not required to perform DBE mode enablement (e.g., if DBE is considered always enabled for STA's supported BW), then the STA may perform DSO enablement over DBE BW.

In both of the aforementioned where STAs enable/negotiate DSO before DBE mode is enabled/updated or after DBE is enabled/updated, the AP may perform DSO for STAs for which DSO is enabled/negotiated over the DBE BW (or a smaller BW than the DBE BW), as per DSO procedure defined.

In some embodiments, when the AP enables DBE mode or updates its DBE BW (e.g., updating the DBE BW from 160 MHz to 320 MHz or vice versa), the AP and STAs continue to perform DSO over the new/updated DBE BW using DSO subband(s) per already performed DSO enablement/negotiation if those apply for the new/updated DBE BW. For example, if the DBE BW is updated from 320 MHz to 160 MHz, an 80 MHz STA that has DSO subband negotiated as S80 subband can continue to operate with DSO over S80 (over DBE BW of 160 MHz) and does not need to renegotiate DSO with the AP. On the other hand, if an 80 MHz STA had negotiated DSO subband to be in S160 subband, then that STA cannot operate with DSO over the 160 MHz DBE BW, and for such STA the DSO would be disabled. Such a STA would need to renegotiate DSO subband with the AP for DSO operation over the updated DBE BW of 160 MHz. In one embodiment, any such 80 MHz STA may be considered by default to have the DSO subband of S80 when DBE BW is changed from 320 to 160 MHz. In this case, the STA does not need to renegotiate with the AP for DSO, and both STA and AP will continue to operate with DSO using S80 DSO subband. In another example, if DBE mode is enabled for the case when BSS BW was 160 MHz and DBW BW is now 320 MHz, any STA that has DSO subband of S80 already negotiated over the BSS BW can continue to operate with that DSO subband after DBE mode is enabled with 320 MHz DBE BW. In another example, if DBE BW changes from 160 to 320 MHz, the 80 MHz STAs that had enabled DSO with S80 subband can continue to operate using DSO with S80 as the DSO subband. If the STA desires, it may renegotiate a different 80 MHz DSO subband with the AP over the updated 320 MHz of DBE BW in both cases above. Similar behavior may be applicable for 20 MHz STAs that have enabled DSO. If DBE mode is enabled or DBE BW changes, then such STAs may continue to operate with already negotiated 20 MHz DSO subband(s) or may renegotiate different 20 MHz DSO subband(s). In general, when DBE mode is enabled or DBE BW is updated by the AP, any already negotiated DSO subband for a STA can continue to be used if that DSO subband is within the DBE BW. If the already negotiated DSO subband is not within the DBE BW, then DSO is disabled for that STA. If DBE mode is disabled, then any already negotiated DSO subband that is still within the BSS BW can continue to be used for the STA, and if any already negotiated DSO subband is now outside the BSS BW, the DSO becomes disabled for that STA. This rule can also be applied when AP's BSS BW is updated using other mechanisms such as operating mode notification (OMN) or operating mode indication (OMI) or (extended) channel switch announcement (CSA or ECSA). In these cases, as well, if any already negotiated DSO subband for a STA lies within the updated BSS BW, then that DSO subband can continue to be used for the STA. On the other hand, after BSS BW update (using OMN, OMI, (E)CSA or another mechanism) if any already negotiated DSO subband for a STA now lies outside the updated BSS BE, then DSO is disabled for that STA. Then such a STA would need to renegotiate a different DSO subband with the AP.

When DBE mode is disabled by the AP, then DSO may also be disabled over the DBE BW. Disablement of the DSO mode over the DBE BW may be by default (e.g., DSO gets disabled over DBE BW when DBE mode is disabled) or explicitly signaled in the critical update notification for DBE mode disablement. Alternatively, a separate critical update notification may be sent to disable DSO over DBE BW, that takes effect at the same time as the DBE mode disablement.

When DSO is disabled over DBE BW, the AP may keep DSO enabled over the BSS BW or disable DSO mode for BSS BW. DSO mode over the BSS BW may be enabled/disabled by the AP using the UHR BSS parameters critical update notification. The AP may signal enablement/disablement of DSO mode over BSS BW and enablement/disablement of DSO mode over DBE BW in the same Critical Update (CU) notification or different CU notifications.

FIG. 3 illustrates an example for DBE operation, where the AP and STAs are operating with BSS BW of 40 MHz. Then the AP announces DBE mode enablement with a DBE BW of 160 MHz in beacons, probe response etc. using BSS parameters critical update advance notifications that includes when DBE mode enablement is to take effect (at a certain TBTT). At the TBTT where the DBE mode is enabled, the AP and DBE supporting STAs operate over expanded DBE BW. Some DBE supporting STAs (STAs a, b, c) operate with expanded BW of 80 MHz, and other DBE supporting STAs (STAs x, y, z) operate with expanded BW of 160 MHz. The AP then announces disablement of DBE mode in beacons, probe response etc. using BSS parameters critical update advance notifications and indicates the TBTT when DBE mode will be disabled. When the DBE mode is disabled, the AP and DBE supporting STAs go back to operating with the BSS BW of 40 MHz.

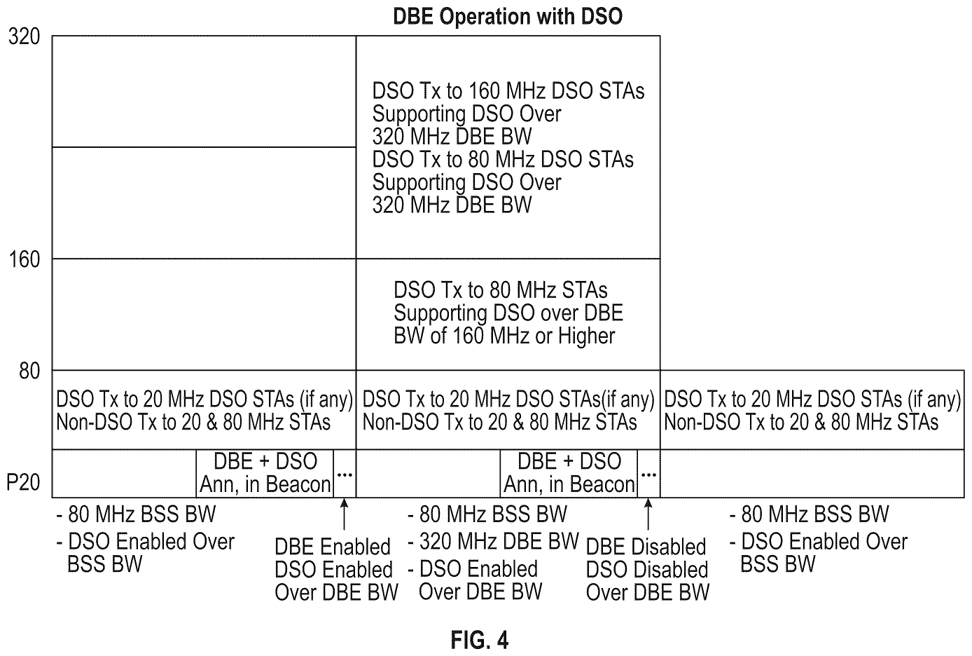

FIG. 4 illustrates an example for DBE operation with DSO. After DBE mode is enabled, the AP may perform DSO operation over the expanded DBE BW and DSO operation over DBE BW becomes disabled after AP is not operating with expanded DBE BW. As shown in FIG. 4, DSO may be enabled (over the BSS BW) before DBE is enabled, and DSO may remain enabled over the BSS BW after DBE mode becomes disabled. In other cases, the AP may not have DSO enabled over BSS BW before or after DBE mode is enabled. Once computing device 900 uses DSO over the expanded BW of DBE for client devices that support DSO in stage 230, method 200 may then end at stage 240.

Consistent with other embodiments of the disclosure, enterprise deployments where BSS BWs may typically be narrow (20/40/80 MHz) due to frequency reuse, may benefit from using DSO when the BW is expanded with DBE. When operating in DBE mode, an AP may use DSO for STAs that support both DSO and DBE, to move those STAs to DSO subbands over the DBE BW. The following disclosure describes behavior for DBE operation with DSO, with the goal to minimize changes needed for using DSO over the DBE BW.

For DBE and DSO operation, considering 80 MHz and 160 MHz STAs as examples, if a STA supports and enables both DBE and DSO, then it may be moved to DSO subbands in the DBE BW. A BSS may benefit from DBE BW (160/320 MHz) even if only a few STAs may operate over that DBE BW, provided there are DSO STAs that may be moved to DSO subbands in the DBE BW.

For 80 MHZ STAs, following example behavior may be applicable for supporting DSO over the DBE BW:
STA indicates max BW capability to be 80 MHz in baseline BW capability indication.
STA indicates DBE support (with max DBE BW of 80 MHz) and enables DBE
STA indicates DSO Support.
STA enables/negotiates 80 MHz DSO subbands with the AP (either before or after DBE mode is enabled).
AP is initially operating over 20/40 MHz BSS BW, and it expands to DBE BW of 160 or 320 MHz.
Then such 80 MHz STA can be moved to 80 MHz DSO subbands in S80 or S160 (per DSO negotiation)—since STA supports/enables both DBE and DSO.
   For 160 MHz STAs, following example behavior may be applicable for supporting DSO over the DBE BW:
STA indicates max BW capability to be 160 in baseline BW capability

indication.
STA indicates DBE support (with max DBE BW of 160 MHz) and enables DBE.
STA indicates DSO Support.
STA enables DSO (for 160 MHz DSO subband) with the AP (either before or after DBE mode is enabled).
AP is initially operating over 20/40 MHz BSS BW, and it expands to DBE BW of 320 MHz.
Then such 160 MHz STA can be moved to S160 DSO subband—since STA supports/enables both DBE and DSO.

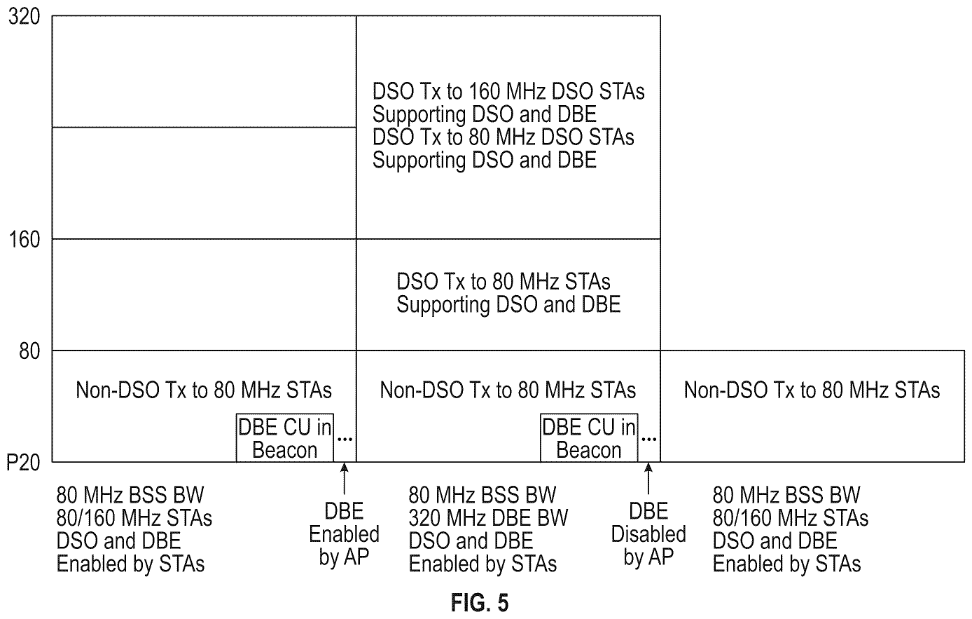

FIG. 5 illustrates an example DBE operation with DSO when associated STA are 80/160 MHz STAs. The AP is operating over a BSS BW of 80 MHz and no DSO operation is performed before DBE mode is enabled. As shown in FIG. 5, after DBE mode is enabled, the AP may perform DSO for 80/160 MHz supporting STAs that support and enable DSO and DBE over the DBE BW, by moving DSO STAs to S80 and/or S160 subbands. After DBE mode is disabled, no DSO operation is performed for STAs. It is desired for STAs to enable DSO and DBE before DBE mode is enabled to

avoid gold-rush of DSO (and DBE) enablement requests to the AP, as described above.

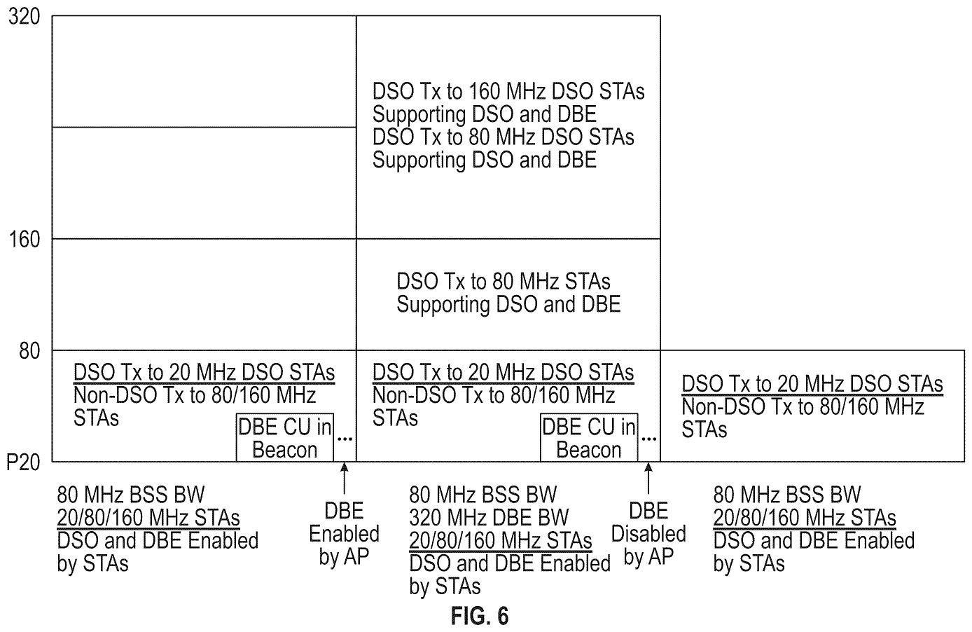

FIG. 6 illustrates an example DBE operation with DSO when associated STA are 20/80/160 MHz STAs. The AP is operating over a BSS BW of 80 MHz and DSO may be performed over the BSS BW for 20 MHz STAs that support and enable DSO, even before DBE mode is enabled. After DBE mode is enabled, the AP may additionally perform DSO for 80/160 MHz STAs that support and enable DSO and DBE over the DBE BW, by moving those DSO STAs to S80 and/or S160 subbands. After DBE mode is disabled, no DSO operation is performed for 80/160 MHz STAs. The AP may continue to keep DSO mode enabled and perform DSO for 20 MHz STAs.

The following describes example capability indication where the AP and STAs may indicate capability for using DSO over the DBE BW. DBE Support=1 may indicate that the STA/AP may be capable of operating over the DBE BW up to the max BW capability indicated by the STA or the AP, respectively. DSO Support=1 may indicate that the STA/AP may be capable of DSO for 20/80/160 MHz STAs, e.g., an 80 MHz STA may be moved to other 80 MHz DSO subbands and a 160 MHz STA may be moved to S160 DSO subband. For an AP DSO Support=1 indicates that the AP supports moving STAs to allowed DSO subbands. A STA that sets both DBE Support=1 and DSO Support=1 may indicate that the STA can operate up to its max BW capability over the DBE BW and can be moved to relevant DSO subbands. For example, if a STA's max supported BW capability is 80 MHz, and it sets both DBE Support and DSO Support to 1, then the STA may support moving to DSO subbands over 160/320 MHz DBE BW. An AP that sets DBE Support =1 and DSO Support=1 may indicate that it can perform BW expansion up to AP's max DBE BW capability and supports scheduling STAs to 20/80/160 DSO subbands in those DBE BWs. These existing capability fields may suffice for supporting DSO operation over DBE BW.

Consistent with embodiments of the disclosure, an AP may enable use of DSO for DBE. In one embodiment, there may be no dynamic enable/disable indication for DSO from the AP side. DSO may always be enabled for an AP to use if supported by the AP (AP has DSO Support=1). DBE may explicitly be enabled by the AP by setting DBE Enabled=1. When an AP that supports DSO also enables DBE, it may imply that the AP can perform DSO over the DBE BW (e.g., because the AP supports performing DSO over all possible DSO subbands).

Furthermore, a STA (e.g., a client device or a non-AP STA) may enable use of DSO for DBE BW. A STA may use UHR's Operating Modes and Parameters (OMP) procedure to enable DBE and DSO modes with the AP. The STA sends an OMP request (which is a UHR Link Reconfiguration Request frame) to the AP to enable DSO and negotiate DSO subband(s) and other DSO parameters over the expanded DBE BW with the AP. The AP sends an OMP response (which is a UHR Link Reconfiguration Notify frame) to the STA to indicate selected DSO subband for the DBE BW. If the STA is an 80 MHz STA (or 20 MHz STA) and it cannot accept the AP indicated DSO subband (since there are multiple possible DSO subbands) over the DBE BW in the OMP response, then it can send another OMP frame (e.g. an OMP confirm frame) to indicate a rejection for the DSO subband indicated by the AP. In this case, no DSO subband is enabled over DBE BW and no DSO can be done. If STA can accept AP indicated DSO subband then it does not send any frame to AP after receiving the OMP response. Then DSO subband is negotiated between the AP and the STA. After the STA has enabled/negotiated DSO with the AP, the STA may be moved to negotiated DSO subband(s). A STA must enable both DBE and DSO for AP to use DSO over the DBE BW. Consistent with embodiments of the disclosure, for performing DSO over DBE BW, a STA may perform DSO enablement/negotiation with the AP using OMP up to the maximum supported DBE BW by the AP. For example, if BSS BW is 40 MHz, and AP supports DBE up to 320 MHz, then DSO and DBE supporting STAs can perform DSO negotiation up to 320 MHz. STAs should perform DSO enablement/negotiation over max DBE BW in advance of DBE mode enablement, to avoid gold rush of STAs performing DSO enablement/negotiation after DBE mode enablement. The AP should also support receiving DSO enablement/negotiation from STAs after DBE mode is enabled. A non-AP STA must enable both DBE and DSO for AP to use DSO over the DBE BW. The non-AP STA may need to enable DBE and DSO separately (in any order), because the DSO OMP procedure may be different than DBE. For example, if the STA's max supported BW is 160 MHz, and it enables both DSO and DBE, then when DBE BW is expanded to 320 MHz, the AP can perform DSO and move the STA to S160 subband.

In enterprise deployments where BSS BWs are typically low (20/40/80 MHz) due to frequency reuse, BSS may benefit from using DSO when the BW is expanded with DBE. A BSS may benefit from DBE BW (160/320 MHz) even if only a few STAs can operate over that DBE BW, if there are DSO STAs that can be moved to DSO subband in the DBE BW. When an AP supports DSO and DBE, it can move DSO and DBE supporting STAs to DSO subband in the DBE BW, if those STAs have enabled DSO and DBE. DSO may be supported over DBE BW with following behavior and rules: i) AP and STAs may use DBE and DSO capability fields to indicate support for DSO over DBE BW; ii) when an AP that supports DSO also enables DBE, it implies that AP can perform DSO over the DBE BW; iii) for supporting DSO over DBE BW, allow DBE supporting STAs to perform DSO enablement/negotiation using OMP up to maximum supported DBE BW by the AP; and iv) STAs should perform DSO enablement/negotiation over max DBE BW in advance of DBE mode enablement, to avoid gold rush of STAs performing DSO enablement.

An AP may use DSO over the DBE BW when DBE mode is enabled, for non-AP STAs that support and have enabled both DBE and DSO. Embodiments of the disclosure may allow DBE supporting STAs to perform DSO enablement/negotiation with the AP using OMP procedure up to the maximum supported DBE BW by the AP. Non-AP STAs should perform DSO enablement/negotiation over the maximum supported DBE BW of the AP in advance of DBE mode enablement, to avoid gold rush of STAs performing DSO enablement/negotiation after DBE mode enablement.

### Other Embodiments of the Disclosure

Other embodiments may comprise DSO coexistence with DBE. A first step with this embodiment may comprise AP and STA indicate DSO capability and parameters for DBE BW.

### AP Side DSO and DBE Parameters

With respect to AP's DSO and DBE parameters, an AP may indicate support for DSO in the UHR Capabilities element (or another element) in Beacon, Probe Response, or another management frame. The AP may also indicate if DSO is currently enabled in UHR Operation or another element.

An AP that supports DBE may also indicate whether it supports DSO in the DBE expanded BW. This may be indicated in the UHR Capabilities and/or UHR Operation or another element in Beacon, Probe Response or another management frame. If the AP supports DSO over entire DBE BW, then it may indicate such using a field/subfield in Beacon etc. For example, the AP may indicate ‘DSO Supported over DBE’ using a field/bit.

In other cases, the AP may have restrictions/or scheduling constraints and may support DSO only for some parts of the expanded DBE BW. In those cases, the AP may indicate for which channels or part of the expanded DBE BW it supports DSO. The AP may indicate the set of channels/expanded BW where it supports DSO operation in one of the following ways: i) provide a list of DSO Enabled Channels; or ii) instead of indicating list of DSO enabled channels, along with Max DBE BW, the AP may also indicate a ‘Max BW Supported for DSO’ parameter that provides the Max BW over which DSO is supported

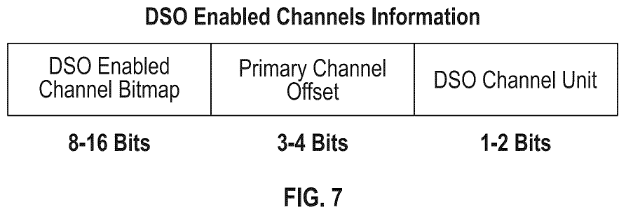

As illustrated in FIG. 7, when providing a list of DSO Enabled Channels, embodiments of the disclosure may indicate this as DSO enabled channels bitmap, where Least Significant Bit may correspond to lowest numbered channel and setting a bit to 1 indicates that the DSO is enabled for that channel. A primary channel offset field can provide relative position of a primary channel with respect to the lowest numbered channel in the DSO enabled channels list, to figure out the lowest DSO channel indicated. A DSO Channel Unit field can indicate the channel width unit of each DSO channel.

Moreover, embodiments of the disclosure may use a different format for indicating set of DSO enabled channels. The DSO enabled channels may list the channels that are outside the AP's operating BW, and can indicate channels in the DBE BW. This enables the AP to use the DSO enabled channels field/element to indicate DSO enabled channels in the expanded BW as well.

As stated above, instead of indicating a list of DSO enabled channels, the AP may also indicate a ‘Max BW Supported for DSO’ parameter that provides the Max BW over which DSO is supported. For example an AP with 80 MHz operating BW can support 160-320 MHz expanded BW for DBE. If such an AP has limit to support DSO only within P80 and S80 (total 160 MHz BW), then DSO subchannel switches may only be done in P160. In this case, the AP may indicate its Max BW Supported for DSO=160 MHz, although Max DBE BW=320 MHz.

### STA DSO and DBE Parameters

A DSO capable station may indicate its DSO capability and parameters to the AP, in UHR Capabilities or another element in (Re)Association Request or another operating mode management frame. DSO parameters provided by the STA may include:
DSO Support—set to enable or disable
Supported DSO subchannels list-indicates set of one or more subchannels where STA can operate with DSO. Can indicate one or more of following:
   i. DSO supported for any subchannel in AP's operating BW and expanded bandwidth indicated for DBE.
   ii. All subchannels in AP's operating BW are supported for DSO
   iii. Set of DSO subchannels supported, including within AP's operating BW and outside AP's operating BW (and within the AP's DBE expanded BW)
DSO Switching Delay(s)—reports STA's switching delay for moving to DSO subchannel and then moving back to the primary channel.

Embodiments may include supported DSO subchannels. A STA may indicate that it only supports channels for DSO in AP's operating BW and does not support any DSO subchannels in the DBE expanded BW. For such a STA, the DSO operation may be performed only within the AP's operating BW. For STAs that support DSO subchannels in the AP's DBE expanded BW, when the AP is operating with expanded BW, it may move those STAs to DSO subchannels within the expanded BW as well.

With respect to DSO Switching Delay(s), a STA may have different switching delays for moving to DSO channel (DSO switching delay) and then moving back to primary channel (DSO switch back delay). So, the STA may report two switching delay parameters—DSO Switching Delay and DSO Switch back delay. An STA may report switching delay that applies for switching to any DSO supported subchannel or can report this as a list of (DSO subchannel, DSO switching delay, DSO switch back delay) tuples, where switching delays may be different for different DSO subchannels. This can be used by the STA to indicate a different DSO switching delay for DSO subchannels in the DBE expanded BW.

A second step with this embodiment may comprise DSO operation with expanded DBE BW. When a STA is DSO capable, then the AP may signal to that STA in an Initial Control Frame (ICF) to operate on different parts of the AP's BSS operating BW based on DSO subchannels indicated for that STA in the ICF (and perhaps explicit DSO switch indication), and the STA may use a respond with an Initial Control Response (ICR) on the indicated DSO subchannel (e.g., indicated using the Resource Unit (RU) allocation for that STA for ICR). The STA may perform channel switch to the indicated DSO subchannel and then send an ICR (response frame) to the AP on the switched DSO subchannel.

The aspect here may be DSO operation with dynamically expanded DBE BW. Once the AP has expanded its BW to DBE expanded BW, then it can also signal DBE supporting STAs (that support operating over the expanded BW), to operate over the supported DSO subchannel in the expanded BW (as per the STA's DSO capability and parameters indicated to the AP earlier). When the AP is operating with the expanded BW, in the ICF sent to trigger DSO subchannel switch (which can also trigger non DSO STAs in the same trigger), the AP may only allocate RUs for sending ICR response in the expanded DBE BW for DBE and DSO supporting STAs for signaling DSO switch to DSO subchannels (or subbands). To other non-DBE supporting STAs, the ICF may indicate DSO switch onto to DSO subchannels in the AP's BSS operating BW.

Padding provided in the ICF that triggers the DSO switch needs to account for DSO switching delays for DSO supporting STAs to switch to DSO subchannels in the expanded DBE BW. This may be more (or different) than the switching delay for DSO subchannel switch in the BSS Operating BW.

In one embodiment, even if a STA does not support DBE expanded BW, it may still indicate support for DSO subchannels in the expanded BW in its supported DSO subchannels. Likewise a DBE supporting STA that can operate in the expanded BW may indicate that it does not support DSO operation in the expanded BW due to device specific constraints. DSO subchannel switch should only be indicated in the ICF for STAs that support DSO operation in the expanded BW (either DBE supporting STAs or even non-DBE STAs).

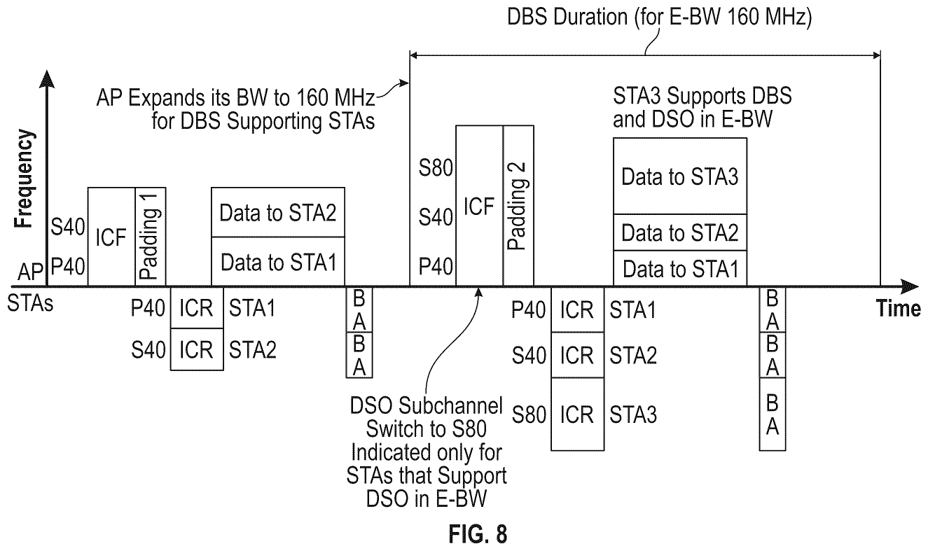

FIG. 8 illustrates DSO operation with DBE expanded BW. After the AP dynamically expands its BW to 160 MHz using DBE operation, it can allocate DSO subchannels in the expanded BW for STAs that support operating in the expanded BW. STA3 is a DBE supporting STA that supports operating over the expanded BW of 160 MHz and supports DSO operation in S80. As part of DSO operation in the expanded BW, the AP may signal only STA3 to switch to DSO subchannel in the expanded BW. The Padding 2 delay in ICF may account for DSO switching delay for STA3 to switch to DSO subchannel in S80, besides accounting for DSO switching delay for STA1 and STA2 within BSS operating BW.

FIG. 9 shows computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for providing DBE operation with DSO as described above with respect to FIG. 2. Computing device 900, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
operating a computing device in Dynamic Bandwidth Expansion (DBE) mode;
operating the computing device in Dynamic Subband Operation (DSO) mode; and
using DSO over expanded DBE Bandwidth (BW) for at least one client device that supports and enable DSO over expanded DBE BW.

2. The method of claim 1, wherein:
the computing device supports DSO over the expanded DBE BW when the computing device has indicated support for DBE and DSO; and
the at least one client device supports DSO over the expanded DBE BW when the at least one client device has indicated support for DBE and DSO.

3. The method of claim 1, further comprising:
indicating by the computing device a capability to support DSO over the expanded DBE BW using one of a DSO support field and a DSO support over DBE BW field; and
indicating by the at least one client device a capability to support DSO over the expanded DBE BW using one of a DSO support field or a DSO support over DBE BW field.

4. The method of claim 1, further comprising at least one of:
the DSO mode being enabled at the computing device at one of before the DBE mode is enabled or after the DBE mode is enabled, and the DSO mode is always enabled at the computing device when the DSO mode is supported by the computing device.

5. The method of claim 1, further comprising the computing device enabling using DSO over the expanded DBE BW when the computing device has indicated support for DSO and has enabled DBE.

6. The method of claim 5, further comprising indicating by the computing device enablement of using DSO over the expanded DBE BW using one of a DSO enabled field and a DSO enabled over DBE BW field.

7. The method of claim 1, further comprising the at least one client device enabling both DBE mode and DSO mode with the computing device.

8. The method of claim 1, further comprising using an already negotiated at least one DSO subband for the at least one client device for DSO after the DBE mode is enabled or DBE bandwidth is updated if the already negotiated at least one DSO subband is within the DBE BW.

9. The method of claim 8, further comprising the at least one client device enabling using DSO over the expanded DBE BW with the computing device at one of before the DBE mode is enabled or after the DBE mode is enabled at the computing device.

10. The method of claim 9, further comprising the at least one client device enabling using DSO over the expanded DBE BW during a time when a Basic Service Set (BSS) parameters critical update announcement is being sent for enabling DBE mode.

11. The method of claim 9, wherein the at least one client device enabling using DSO over the expanded DBE BW comprises the at least one client device negotiating with the computing device one or more DSO subband to be used over the expanded DBE BW.

12. The method of claim 11, further comprising at least one of:
the at least one client device negotiating with the computing device the one or more DSO subband before the DBE mode is enabled for at least one possible expanded DBE bandwidths, and
the at least one client device negotiating with the computing device at least one DSO subband after the DBE mode is enabled for the expanded DBE BW.

13. The method of claim 1, further comprising the computing device updating the DBE BW and using DSO over the updated DBE BW for the at least one client device that supports and enables DSO over the updated DBE BW.

14. The method of claim 13, further comprising the at least one client device using an already negotiated at least one DSO subband for DSO operation over the updated DBE BW when the at least one DSO subband is within the updated DBE BW.

15. The method of claim 13, further comprising disabling DSO for the at least one client device after DBE BW is updated if an already negotiated at least one DSO subband is outside the updated DBE BW.

16. The method of claim 13, further comprising the at least one client device renegotiating the at least one DSO subband for DSO operation over the updated DBE BW.

17. The method of claim 16, further comprising at least one of:
disabling DSO for the at least one client device after the DBE mode is disabled if an already negotiated at least one DSO subband is outside the BSS BW, and
continuing to use DSO for the at least one client device over the BSS BW after the DBE mode is disabled if an already negotiated at least one DSO subband is within the BSS BW.

18. The method of claim 1, further comprising the computing device disabling the DBE mode and stop using DSO over the expanded DBE BW.

19. A system comprising:
a memory storage; and
a processing unit coupled to the memory storage, wherein the processing unit is operative to:
operate in Dynamic Bandwidth Expansion (DBE) mode;
operate in Dynamic Subband Operation (DSO) mode; and
use DSO over expanded DBE Bandwidth (BW) for at least one client devices that support and enable DSO over expanded DBE BW.

20. A non-transitory computer-readable medium that stores a set of instructions which when executed perform a method executed by the set of instructions comprising:
operating a computing device in Dynamic Bandwidth Expansion (DBE) mode;
operating the computing device in Dynamic Subband Operation (DSO) mode; and
using DSO over expanded DBE Bandwidth (BW) for at least one client devices that support and enable DSO over expanded DBE BW.
